(19) United States
(12) Patent Application Publication
(10) Pub. No.: US 2017/0173829 A1
(43) Pub. Date: Jun. 22, 2017

(54) CYLINDRICAL ARTICLE MADE OF FIBER-REINFORCED RESIN MATERIAL, INJECTION MOLDING MOLD THEREOF, AND INJECTION MOLDING METHOD

(71) Applicant: ENPLAS CORPORATION, Saitama (JP)

(72) Inventor: Kenjiro TAKI, Saitama (JP)

(73) Assignee: ENPLAS CORPORATION, Saitama (JP)

(21) Appl. No.: 15/325,606

(22) PCT Filed: May 26, 2015
(86) PCT No.: PCT/JP2015/065019

§ 371 Date: Jan. 11, 2017

(30) Foreign Application Priority Data
Jul. 15, 2014 (JP) 2014-144673

(51) Int. Cl. B29C 45/00; B29C 45/26

(52) U.S. Cl. CPC B29C 45/0005; B29C 45/0046; B29C 45/26; B29K 2105/06

(57) ABSTRACT

An injection molding mold 2 where a molten resin containing reinforcing fibers is injected from a gate 11 into a cavity 5 to join the molten resins containing the reinforcing fibers together in the cavity 5 to form a weld portion. The injection molding mold 2 includes a reinforcing fiber orientation change concave portion 20 formed at a position displaced from the weld portion. The reinforcing fiber orientation change concave portion 20 opens to the cavity 5. The reinforcing fiber orientation change concave portion 20 causes the molten resins containing the reinforcing fibers 25 in the cavity 5 to partially flow into the reinforcing fiber orientation change concave portion 20 to disturb directions of the reinforcing fibers at the weld portion. Consequently, the reinforcing fibers at the weld portion and near the weld portion in the cylindrical article 1 tangle, thus improving the strength at the weld portion in the cylindrical article 1.

### TECHNICAL FIELD

The present invention relates to a cylindrical article made of a fiber-reinforced resin material, an injection molding mold thereof, and an injection molding method to improve strength at a weld portion generated by injection molding.

### BACKGROUND ART

As illustrated in FIG. 14, there has been conventionally known an injection molding method (see PLT 1) that injects a molten resin from a pinpoint gate 100 into a cavity 102 in a mold 101 to manufacture a cylindrical article 103 (see FIG. 15) to which a shape of the cavity 102 is transferred.

### CITATION LIST

### Patent Literature

PTL 1

Japanese Patent No. 3383971

### SUMMARY OF INVENTION

### Technical Problem

However, as illustrated in FIG. 14 and FIG. 15, after the molten resin is injected from the pinpoint gate 100 into the cavity 102 in the mold 101, the conventional injection molding method forms a weld portion 104 at a part where the molten resins join together in the cavity 102. A problem that this weld portion 104 deteriorates strength of the cylindrical article 103 has been pointed out. Especially, in the cylindrical article 103 on which the injection molding has been performed using a fiber-reinforced resin material, reinforcing fibers 105 at the weld portion 104 are arranged in one direction (molten resin flowing direction) (see FIG. 16). This has a problem that press-fitting the cylindrical article 103 to a shaft is likely to cause a crack in the weld portion 104.

Therefore, an object of the present invention is to provide a cylindrical article made of a fiber-reinforced resin material, an injection molding mold thereof, and an injection molding method to improve strength of a weld portion.

### Solution to Problem

The present invention relates to an injection molding mold 2 for a cylindrical article 1 where a molten resin containing reinforcing fibers 25 is injected from a gate 11 into a cavity 5 to join the molten resins containing the reinforcing fibers 25 together in the cavity 5 to form a weld portion 24. The present invention includes a reinforcing fiber orientation change concave portion 20 formed at a position displaced from the weld portion 24. The reinforcing fiber orientation change concave portion 20 opens to the cavity 5. The reinforcing fiber orientation change concave portion 20 causes the molten resins containing the reinforcing fibers 25 in the cavity 5 to partially flow into the reinforcing fiber orientation change concave portion 20 to disturb directions of the reinforcing fibers 25 at the weld portion 24.

The present invention relates to an injection molding method for a cylindrical article 1 that injects a molten resin containing reinforcing fibers 25 from a gate 11 into a cavity 5 to join the molten resins containing the reinforcing fibers 25 together in the cavity 5 to form a weld portion 24. The present invention disposes a reinforcing fiber orientation change concave portion 20 at a position displaced from the weld portion 24. The reinforcing fiber orientation change concave portion 20 opens to the cavity 5. The present invention causes the molten resins containing the reinforcing fibers 25 filling the inside of the cavity 5 to partially flow into the reinforcing fiber orientation change concave portion 20 to disturb directions of the reinforcing fibers 25 at the weld portion 24.

The present invention relates to a cylindrical article 1 made of a fiber-reinforced resin material where a molten resin containing reinforcing fibers 25 is injected from a gate 11 into a cavity 5 to join the molten resins containing the reinforcing fibers 25 together in the cavity 5 to form a weld portion 24. In the cylindrical article 1 made of the fiber-reinforced resin material according to the present invention, the molten resins containing the reinforcing fibers 25 in the cavity 5 are partially flown into a reinforcing fiber orientation change concave portion 20 opening to the cavity 5 to disturb directions of the reinforcing fibers 25 at the weld portion 24.

### Advantageous Effects of Invention

With the present invention, the directions of the reinforcing fibers at the weld portion and near the weld portion in the injection-molded cylindrical article are disturbed. The reinforcing fibers at the weld portion and near the weld portion in the cylindrical article tangle. Accordingly, the weld portion in the cylindrical article is less likely to be noticeable, and the strength at the weld portion in the cylindrical article is improved.

### BRIEF DESCRIPTION OF DRAWINGS

FIG. 1 are drawings illustrating a structure of an injection molding mold for a cylindrical article according to a first embodiment of the present invention, FIG. 1A is a drawing illustrating the injection molding mold illustrated in FIG. 1B taken along a line A1-A1 (a plan view of a second mold), and FIG. 1B is a vertical cross-sectional view of the injection molding mold (a cross-sectional view of the injection molding mold illustrated taken along a line A2-A2 in FIG. 1A);

FIG. 2 are drawings illustrating the cylindrical article according to the first embodiment of the present invention. FIG. 2A is a front view of the cylindrical article. FIG. 2B is a side view of the cylindrical article viewed from a direction along an arrow C1 in FIG. 2A. FIG. 2C is a cross-sectional view of the cylindrical article illustrated taken along a line A3-A3 in FIG. 2A;

FIG. 3 is a drawing illustrating a relationship between a reinforcing fiber orientation change concave portion and directions of reinforcing fibers in the injection molding mold according to the first embodiment of the present invention;

FIG. 4 are drawings illustrating a structure of an injection molding mold for a cylindrical article according to a second embodiment of the present invention. FIG. 4A is a drawing illustrating the injection molding mold illustrated in FIG. 4B taken along a line A4-A4 (a plan view of the second mold). FIG. 4B is a vertical cross-sectional view of the injection molding mold (a cross-sectional view of the injection molding mold illustrated taken along a line A5-A5 in FIG. 4A);

FIG. 5 are drawings illustrating the cylindrical article according to the second embodiment of the present invention. FIG. 5A is a front view of the cylindrical article. FIG. 5B is a side view of the cylindrical article viewed from a direction along an arrow C2 in FIG. 5A. FIG. 5C is a cross-sectional view of the cylindrical article taken along a line A6-A6 in FIG. 5A;

FIG. 6 is a drawing illustrating a relationship between a separation mark at a molten resin introduction path and directions of the reinforcing fibers in the cylindrical article according to the second embodiment of the present invention;

FIG. 7 are drawings illustrating a structure of an injection molding mold for a cylindrical article according to a third embodiment of the present invention. FIG. 7A is a drawing illustrating the injection molding mold illustrated in FIG. 7B taken along a line A7-A7 (a plan view of the second mold). FIG. 7B is a vertical cross-sectional view of the injection molding mold (a cross-sectional view of the injection molding mold illustrated taken along a line A8-A8 in FIG. 7A);

FIG. 8 are drawings illustrating the cylindrical article according to the third embodiment of the present invention. FIG. 8A is a front view of the cylindrical article. FIG. 8B is a side view of the cylindrical article viewed from a direction along an arrow C3 in FIG. 8A. FIG. 8C is a cross-sectional view of the cylindrical article illustrated taken along a line A9-A9 in FIG. 8A;

FIG. 9 are drawings illustrating a structure of an injection molding mold for a cylindrical article according to a fourth embodiment of the present invention. FIG. 9A is a drawing illustrating the injection molding mold illustrated in FIG. 9B taken along a line A10-A10 (a plan view of the second mold). FIG. 9B is a vertical cross-sectional view of the injection molding mold (a cross-sectional view of the injection molding mold illustrated taken along a line A11-A11 in FIG. 9A);

FIG. 10 are drawings illustrating the cylindrical article according to the fourth embodiment of the present invention. FIG. 10A is a front view of the cylindrical article. FIG. 10B is a side view of the cylindrical article viewed from a direction along an arrow C4 in FIG. 10A. FIG. 10C is a cross-sectional view of the cylindrical article illustrated taken along a line A12-A12 in FIG. 10A;

FIG. 11 are drawings illustrating a structure in which a pinpoint gate of the injection molding mold illustrated in FIG. 1 is changed to a side gate. FIG. 11A is a drawing illustrating the injection molding mold illustrated in FIG. 11B taken along a line A13-A13 (a plan view of the second mold). FIG. 11B is a vertical cross-sectional view of the injection molding mold (a cross-sectional view of the injection molding mold illustrated taken along a line A14-A14 in FIG. 11A);

FIG. 12 are drawings illustrating a structure in which the pinpoint gate of the injection molding mold illustrated in FIG. 1 is changed to a tunnel gate. FIG. 12A is a drawing illustrating the injection molding mold illustrated in FIG. 12B taken along a line A15-A15 (a plan view of the second mold). FIG. 12B is a vertical cross-sectional view of the injection molding mold (a cross-sectional view of the injection molding mold illustrated taken along a line A16-A16 in FIG. 12A);

FIG. 13 are drawings illustrating a structure in which the one-point gate of the injection molding mold illustrated in FIG. 1 is changed to multipoint gates. FIG. 13A is a drawing illustrating the injection molding mold illustrated in FIG. 13B taken along a line A17-A17 (a plan view of the second mold). FIG. 13B is a vertical cross-sectional view of the injection molding mold (a cross-sectional view of the injection molding mold illustrated taken along a line A18-A18 in FIG. 13A);

FIG. 14 is a drawing illustrating a structure of an injection molding mold for a cylindrical article according to a conventional example;

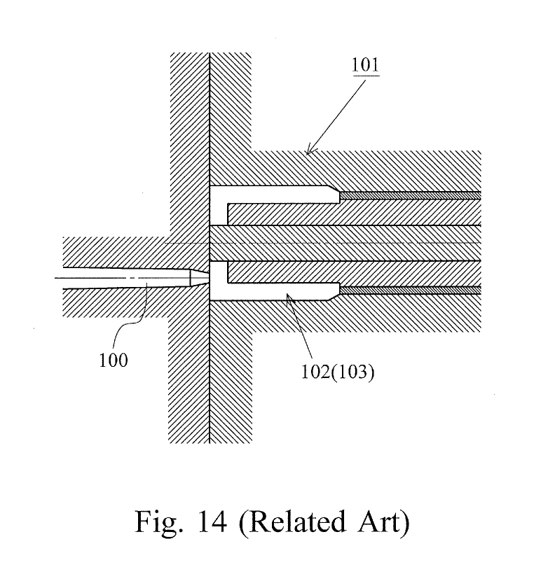

FIG. 15 is an external perspective view of the cylindrical article according to the conventional example; and

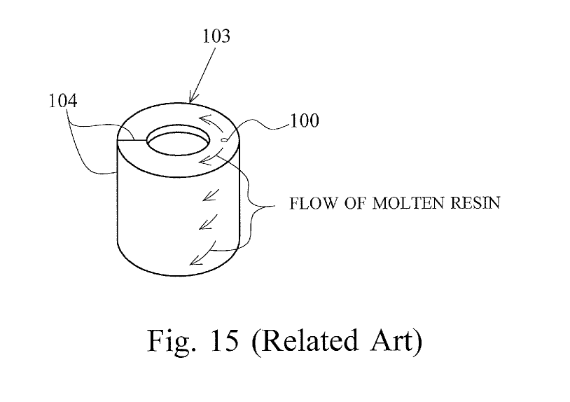

FIG. 16 is a drawing illustrating an orientation of reinforcing fibers at a weld portion and near the weld portion in the cylindrical article according to the conventional example.

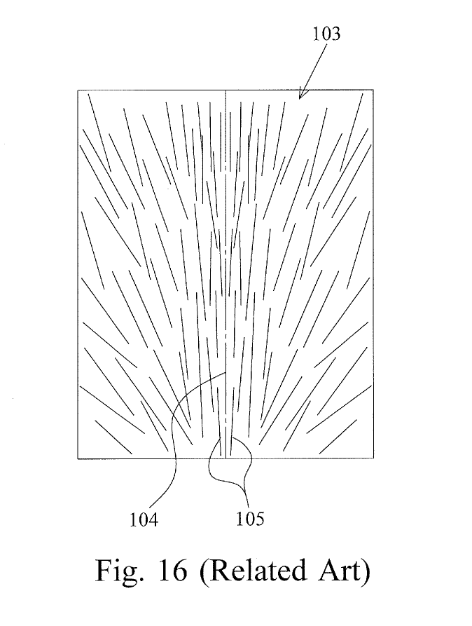

### DESCRIPTION OF EMBODIMENTS

The following describes embodiments of the present invention in detail with reference to the drawings.

### First Embodiment

### (Injection Molding Mold for Cylindrical Article)

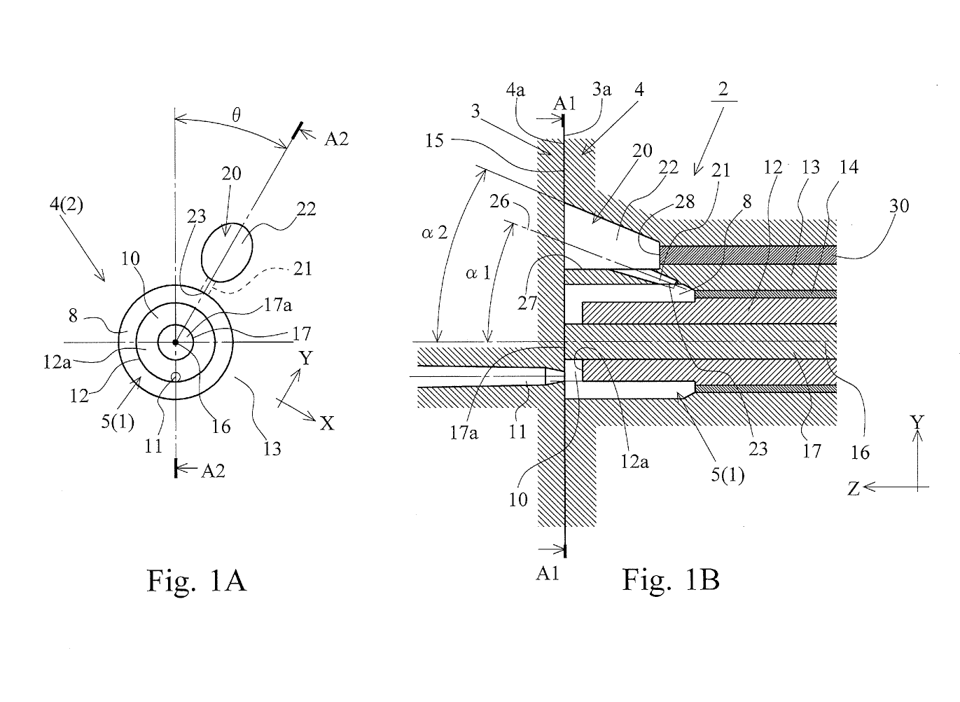

FIG. 1 are drawings illustrating a structure of an injection molding mold 2 for a cylindrical article 1 according to the first embodiment of the present invention. FIG. 1A is a drawing illustrating the injection molding mold 2 illustrated in FIG. 1B taken along a line Al-Al (a plan view of a second mold 4). FIG. 1B is a vertical cross-sectional view of the injection molding mold 2 (a cross-sectional view of the injection molding mold 2 illustrated taken along a line A2-A2 in FIG. 1A).

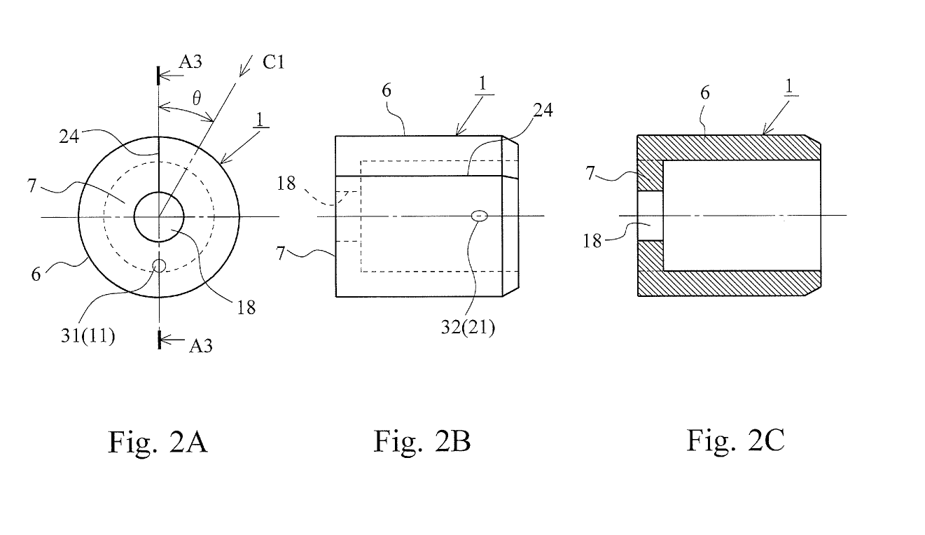

As illustrated in FIG. 1, the injection molding mold 2 forms a cavity 5 on a side of butt planes 3a and 4a of a first mold 3 and the second mold 4. The cavity 5 has a shape that shapes the cylindrical article 1 made of a fiber-reinforced resin material (hereinafter abbreviated as a cylindrical article) illustrated in FIG. 2 so as to be filled with a molten resin containing reinforcing fibers. As illustrated in FIG. 2, the cylindrical article 1 includes a cylinder portion 6 and a hollow circular plate 7 formed integrally with one end of this cylinder portion 6. The cavity 5, which shapes this cylindrical article 1, includes a first cavity 8 to shape the cylinder portion 6 and a second cavity 10. The second cavity 10 is positioned at one end of the first cavity 8 to shape the hollow circular plate 7. This cavity 5 is formed in the second mold 4 such that the first mold 3 covers an opening end of the cavity 5. As the molten resin containing the reinforcing fibers, PA66-GF30 (nylon 66 containing 30% glass fiber), PA6-GF20 (nylon 6 containing 20% glass fiber), PPS-GF40 (polyphenylenesulfide containing 40% glass fiber), POM-GF25 (polyacetal containing 25% glass fiber), or a similar material is used.

The first mold 3 forms a gate 11 (pinpoint gate) open to the second cavity 10, which is formed at the second mold 4. The second mold 4 has an inner mold portion 12 and an outer mold portion 13. The inner mold portion 12 is positioned at an inner peripheral surface side of the first cavity 8. The outer mold portion 13 is positioned at an outer peripheral surface side of the first cavity 8. The second mold 4 houses a cylindrical-shaped ejector sleeve 14 such that the ejector sleeve 14 slidably moves between the inner mold portion 12 and the outer mold portion 13. A distal end of the ejector sleeve 14 is positioned at another end of the first cavity 8. After separation of the first mold 3 and the second mold 4, the ejector sleeve 14 is moved to the left in the drawing in the sliding manner to extrude the cylindrical article 1 that has cooled and hardened after injection molding from the cavity 5.

A distal end 12a of the inner mold portion 12 of the second mold 4 retracts with respect to a parting line (P. L.) 15 between the first mold 3 and the second mold 4, and the distal end 12a serves as a bottom surface of the second cavity 10. The inner mold portion 12 houses a shaft mold 17 extending along a central axis 16 of the inner mold portion 12 at the center thereof. The shaft mold 17 is formed into a round bar shape. A distal end 17a of the shaft mold 17 is bumped against the mold mating surface 3a of the first mold 3. A part positioned in the second cavity 10 forms a center hole 18 of the hollow circular plate 7 of the cylindrical article 1.

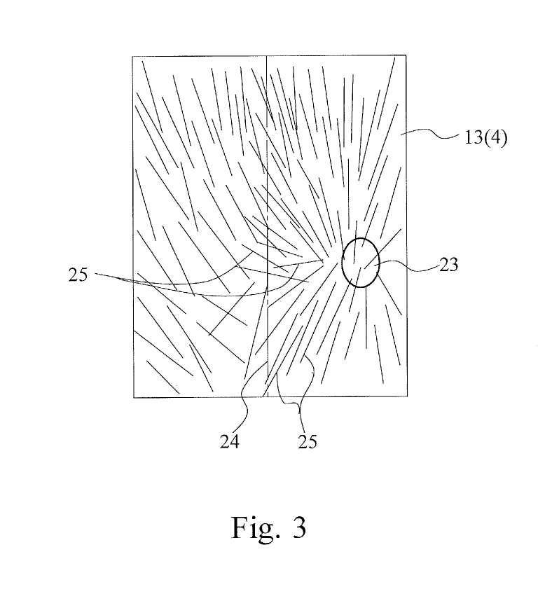

The outer mold portion 13 of the second mold 4 forms a reinforcing fiber orientation change concave portion 20 communicating with the first cavity 8. This reinforcing fiber orientation change concave portion 20 includes a molten resin introduction path 21, which is coupled to the other end of the first cavity 8, and a molten resin chamber 22, which communicates with the first cavity 8 via this molten resin introduction path 21. The molten resin introduction path 21 is formed so as to have an opening area to the first cavity 8 with a size same extent to an opening area of the gate 11 to the second cavity 10. As illustrated in FIG. 1A, an opening 23 of this molten resin introduction path 21 on the first cavity 8 side is disposed at a position additionally rotated by an angle θ clockwise from a position opposed to the gate 11 around the central axis 16 of the inner mold portion 12 (a position rotated clockwise by 180°+θ). Consequently, the opening 23 of the molten resin introduction path 21 on the first cavity 8 side is displaced from a weld portion 24 where the molten resins containing the reinforcing fibers injected from the gate 11 into the cavity 5 join together. The molten resins containing reinforcing fibers 25 filled in the cavity 5 are partially flown from the molten resin introduction path 21 into the molten resin chamber 22, thus disturbing directions of the reinforcing fibers 25 at the weld portion 24 (see FIG. 3). This complexly tangles the reinforcing fibers 25 at the weld portion 24 and near the weld portion 24 in the cavity 5, thus improving strength at the weld portion 24 and a portion near the weld portion 24 in the cylindrical article 1 (see FIG. 3). A volume of the reinforcing fiber orientation change concave portion 20 is determined to have a size where an amount of the molten resin containing the reinforcing fibers to the extent that the directions of the reinforcing fibers 25 at the weld portion 24 and near the weld portion 24 can be disturbed can be housed. The opening 23 of the molten resin introduction path 21 on the first cavity 8 side may be disposed at a position rotated by the angle θ anticlockwise from the position opposed to the gate 11 around the central axis 16 of the inner mold portion 12. The angle θ is set to an optimum angle according to a capacity of the cavity 5, external diameter dimensions of the first cavity 8, or a similar specification. It is only necessary that the opening area of the molten resin introduction path 21 to the first cavity 8 have the size where the molten resin containing the reinforcing fibers in the cavity 5 can flow into the molten resin introduction path 21 after the molten resin containing the reinforcing fibers is filled in the cavity 5. That is, the following cases are assumed. The opening area of the molten resin introduction path 21 to the first cavity 8 is larger than the opening area of the gate 11 to the cavity 5. The opening area of the molten resin introduction path 21 to the first cavity 8 is equal to the opening area of the gate 11 to the cavity 5. The opening area of the molten resin introduction path 21 to the first cavity 8 is smaller than the opening area of the gate 11 to the cavity 5. While the example of the molten resin introduction path 21 opening to the other end of the first cavity 8 is described above, the configuration is not limited to this. The molten resin introduction path 21 may be disposed at the one end of the first cavity 8 or may be disposed between the one end and the other end.

Assuming that an angle formed by the central axis 16 of the inner mold portion 12 and a center line 26 of the molten resin introduction path 21 as al and an open angle of the molten resin chamber 22 with respect to the central axis 16 of the inner mold portion 12 as α2, the reinforcing fiber orientation change concave portion 20 is formed such that α2 is equal to or larger than al (so as to be α2≧α1). A ridgeline 27 close to the first cavity 8 is formed parallel to the central axis 16 of the inner mold portion 12. The molten resin chamber 22 has a cross-sectional shape (trapezoidal-shaped cross-sectional shape) expanding as approaching from a bottom portion 28 to the mold mating surface 4a of the second mold 4 (see FIG. 1B) and has an elliptical shape in plan view (see FIG. 1A). The cross-sectional shape of the molten resin introduction path 21 perpendicular to the center line 26 is a circular shape. The molten resin introduction path 21 is a taper hole whose hole diameter gradually increases from the first cavity 8 side to the molten resin chamber 22 side.

The molten resin containing the reinforcing fibers in the reinforcing fiber orientation change concave portion 20 cools and hardens after the injection molding of the cylindrical article 1. When the first mold 3 and the second mold 4 are separated and the cylindrical article 1 in the cavity 5 is extruded with the ejector sleeve 14, the cylindrical article 1 and the resin in the molten resin introduction path 21 are cut. After that, the resin is extruded from the inside of the reinforcing fiber orientation change concave portion 20 in the second mold 4 to the outside of the second mold 4 with a time difference ejector pin 30. In this respect, when the resin containing the reinforcing fibers that has hardened in the molten resin chamber 22 is pushed with the time difference ejector pin 30, the resin containing the reinforcing fibers that has hardened in the molten resin introduction path 21 moves along a Z-axis direction while sliding along a Y-axis direction to exit from the inside of the molten resin introduction path 21 to the inside of the molten resin chamber 22. Accordingly, the resin containing the reinforcing fibers that has hardened in the reinforcing fiber orientation change concave portion 20 is extruded effortlessly from the inside of the reinforcing fiber orientation change concave portion 20 to the outside of the second mold 4 with the time difference ejector pin 30.

With the injection molding mold 2 according to the above-described embodiment, the directions of the reinforcing fibers 25 at the weld portion 24 and near the weld portion 24 in the injection-molded cylindrical article 1 are disturbed (see FIG. 3). The reinforcing fibers 25 at the weld portion 24 and near the weld portion 24 in the cylindrical article 1 tangle. Accordingly, the weld portion 24 in the cylindrical article 1 is less likely to be noticeable, and the strength at the weld portion 24 in the cylindrical article 1 is improved.

### (Injection Molding Method of Cylindrical Article)

The following describes the injection molding method of the cylindrical article 1 using the injection molding mold 2 illustrated in FIG. 1.

First, the mold mating surface 3a of the first mold 3 and the mold mating surface 4a of the second mold 4 are bumped against one another to clamp the molds. The molten resin containing the reinforcing fibers is injected from the gate 11 of the first mold 3 into the cavity 5. In this respect, the molten resins injected from the gate 11 into the cavity 5 join together at a position circumferentially rotated by 180° from the gate 11. The weld portion (the weld line) 24 is formed at the part where the molten resins containing the reinforcing fibers join together.

When the molten resin containing the reinforcing fibers fills the whole region in the cavity 5, an injection pressure acting on the molten resin containing the reinforcing fibers in the cavity 5 partially extrudes the molten resins containing the reinforcing fibers in the cavity 5 (at the weld portion 24 and near the weld portion 24) into the molten resin introduction path 21, which is displaced from the weld portion 24, and the molten resin chamber 22. This disturbs the directions of the reinforcing fibers 25 at the weld portion 24 and near the weld portion 24, thereby tangling the reinforcing fibers 25 at the weld portion 24 and near the weld portion 24 in the cavity 5 (see FIG. 3).

After the molten resins containing the reinforcing fibers in the cavity 5 and in the reinforcing fiber orientation change concave portion 20 cool and harden, the first mold 3 and the second mold 4 are separated (the molds are opened). In this respect, the cylindrical article (the injection molded product) 1 in the cavity 5 on the second mold 4 side and the gate 11 on the first mold 3 side are separated. A separation mark 31 of the gate 11 is formed on an external surface of the hollow circular plate 7 of the cylindrical article 1 (see FIG. 2A).

Next, the cylindrical article 1 in the cavity 5 is extruded outside the cavity 5 with the ejector sleeve 14. At this time, the molten resin containing the reinforcing fibers that has hardened in the molten resin introduction path 21 and the cylindrical article 1 are cut and separated. A separation mark 32 of the molten resin introduction path 21 is formed on an external surface of the cylinder portion 6 of the cylindrical article 1 (see FIG. 2B).

Next, the time difference ejector pin 30 operates slower than the ejector sleeve 14 to extrude the resin containing the reinforcing fibers that has hardened in the reinforcing fiber orientation change concave portion 20 from the inside of the reinforcing fiber orientation change concave portion 20.

With the injection molding method according to the above-described embodiment, the directions of the reinforcing fibers 25 at the weld portion 24 and near the weld portion 24 in the injection-molded cylindrical article 1 are disturbed. The reinforcing fibers 25 at the weld portion 24 and near the weld portion 24 in the cylindrical article 1 tangle (see FIG. 3). Accordingly, the weld portion 24 in the cylindrical article 1 is less likely to be noticeable, and the strength at the weld portion 24 in the cylindrical article 1 is improved.

### (Cylindrical Article)

The cylindrical article 1 according to the embodiment illustrated in FIG. 2 is formed using the above-described injection molding mold 2 and the above-described injection molding method. This cylindrical article 1 includes the cylinder portion 6 and the hollow circular plate 7 formed integrally with one end of this cylinder portion 6. The separation mark 31 of the gate 11 is formed on the hollow circular plate 7 at the one end of the cylindrical article 1. The separation mark 32 of the molten resin introduction path 21 is formed at a position displaced from the weld portion 24 on the other end of the cylinder portion 6 in the cylindrical article 1. The cylindrical article 1 changes the direction in which the reinforcing fibers 25 at the weld portion 24 and near the weld portion 24 head for the separation mark 31 of the molten resin introduction path 21. Thus, the reinforcing fibers 25 at the weld portion 24 and near the weld portion 24 complexly tangle.

In the cylindrical article 1 according to the embodiment, the directions of the reinforcing fibers 25 at the weld portion 24 and near the weld portion 24 are disturbed, and the reinforcing fibers 25 at the weld portion 24 and near the weld portion 24 tangle (see FIG. 3). Therefore, the weld portion 24 is less likely to be noticeable, improving the strength at the weld portion 24.

### Second Embodiment

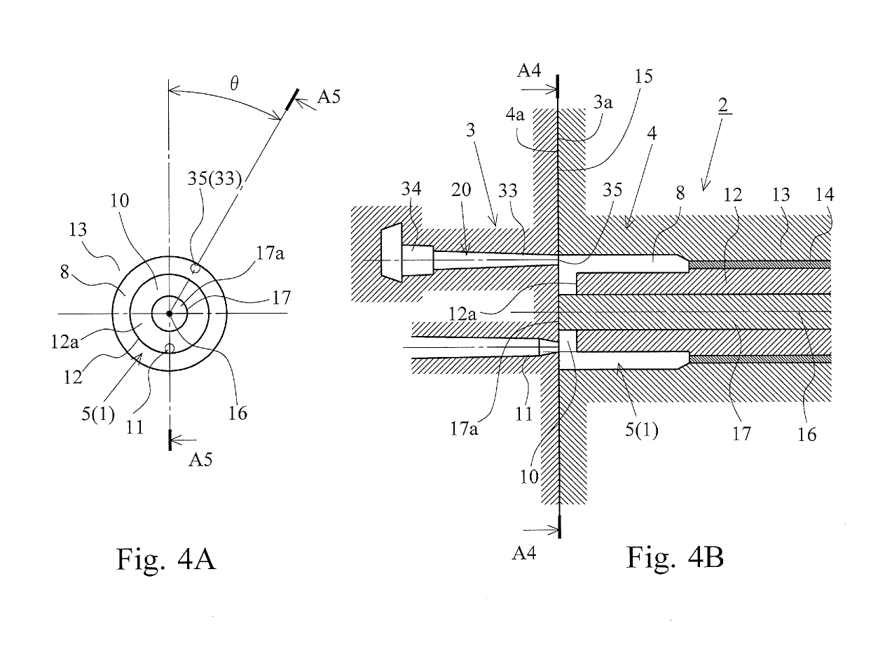

FIG. 4 are drawings illustrating the injection molding mold 2 for the cylindrical article 1 according to the second embodiment of the present invention. FIG. 4 are drawings illustrating a modification of the injection molding mold 2 according to the first embodiment. FIG. 4A is a drawing illustrating the injection molding mold 2 illustrated in FIG. 4B taken along a line A4-A4 (a plan view of the second mold 4). FIG. 4B is a vertical cross-sectional view of the injection molding mold 2 (a cross-sectional view of the injection molding mold 2 illustrated taken along a line A5-A5 in FIG. 4A).

The injection molding mold 2 according to the embodiment differs from the injection molding mold 2 according to the first embodiment in a position of the reinforcing fiber orientation change concave portion 20 and a shape of the reinforcing fiber orientation change concave portion 20. However, since the other basic configurations are similar to those of the injection molding mold 2 according to the first embodiment, reference numerals identical to the injection molding mold 2 according to the first embodiment are assigned to the corresponding components of the injection molding mold 2 according to the first embodiment, and therefore the following omits the explanation overlapping with the explanation of the first embodiment.

The gate 11 formed at the first mold 3 is, similar to the gate 11 of the injection molding mold 1 according to the first embodiment, open to the second cavity 10, which is formed in the second mold 4. The reinforcing fiber orientation change concave portion 20 includes a molten resin introduction path 33, which is coupled to one end of the first cavity 8, and a molten resin chamber 34, which communicates with the first cavity 8 via this molten resin introduction path 33. To obtain a hesitation effect, an opening area of the molten resin introduction path 33 to the first cavity 8 is formed smaller than the opening area of the gate 11 to the first cavity 8.

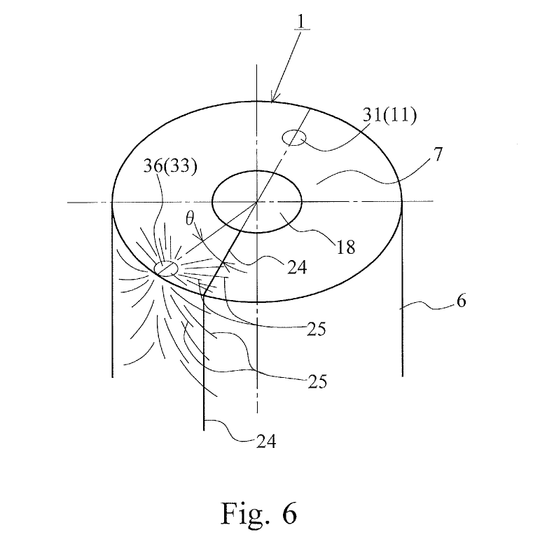

As illustrated in FIG. 4A, an opening 35 of this molten resin introduction path 33 on the first cavity 8 side is disposed at a position additionally rotated by the angle θ clockwise from the position opposed to the gate 11 around the central axis 16 of the inner mold portion 12 (the position rotated clockwise by 180°+θ). Consequently, the opening 35 of the molten resin introduction path 33 on the first cavity 8 side is displaced from the weld portion 24 where the molten resins containing the reinforcing fibers injected from the gate 11 into the cavity 5 join together. The molten resins containing the reinforcing fibers filled in the cavity 5 are partially flown from the molten resin introduction path 33 into the molten resin chamber 34, thus disturbing the directions of the reinforcing fibers 25 at the weld portion 24 and near the weld portion 24 (see FIG. 6). This complexly tangles the reinforcing fibers 25 at the weld portion 24 and near the weld portion 24 in the cavity 5, thus improving the strength at the weld portion 24 and the portion near the weld portion 24 in the cylindrical article 1. The volume of the reinforcing fiber orientation change concave portion 20 is determined to have the size where the amount of the molten resin containing the reinforcing fibers to the extent that the directions of the reinforcing fibers 25 at the weld portion 24 and near the weld portion 24 can be disturbed can be housed. Note that, the reinforcing fiber orientation change concave portion 20 according to the embodiment is formed so as to have the volume almost equivalent to the volume of the reinforcing fiber orientation change concave portion 20 in the injection molding mold 2 according to the first embodiment. The opening 35 of the molten resin introduction path 33 on the first cavity 8 side may be disposed at a position rotated by the angle θ anticlockwise from the position opposed to the gate 11 around the central axis 16 of the inner mold portion 12 (a position rotated clockwise by 180°−θ). The angle θ is set to the optimum angle according to the capacity of the cavity 5, the external diameter dimensions of the first cavity 8, or a similar specification.

With the injection molding mold 2 according to the embodiment, injecting the molten resin containing the reinforcing fibers from the gate 11 into the cavity 5 with the first mold 3 and the second mold 4 clamped (in the state illustrated in FIG. 4) joins the molten resins containing the reinforcing fibers together at a position away from the open position of the gate 11 to the cavity 5 by 180° in the circumferential direction. The weld portion 24 (the weld line) is formed at the joining portion of these molten resins containing the reinforcing fibers (see FIG. 6). When the molten resin containing the reinforcing fibers fills the inside of the cavity 5, the injection pressure acting in the cavity 5 partially extrudes the molten resins containing the reinforcing fibers in the cavity 5 into the molten resin introduction path 33 and the molten resin chamber 34. This disturbs the directions of the reinforcing fibers 25 at the weld portion 24 and near the weld portion 24, thereby tangling the reinforcing fibers 25 at the weld portion 24 and near the weld portion 24 (see FIG. 6).

After the molten resins containing the reinforcing fibers in the cavity 5 and in the reinforcing fiber orientation change concave portion 20 cool and harden, the first mold 3 and the second mold 4 are separated (the molds are opened). In this respect, the gate 11 and the molten resin introduction path 33 are cut and separated from the cylindrical article 1 (the injection molded product) in the cavity 5. The separation mark 31 of the gate 11 and a separation mark 36 of the molten resin introduction path 33 are formed on the cylindrical article 1 in the cavity 5.

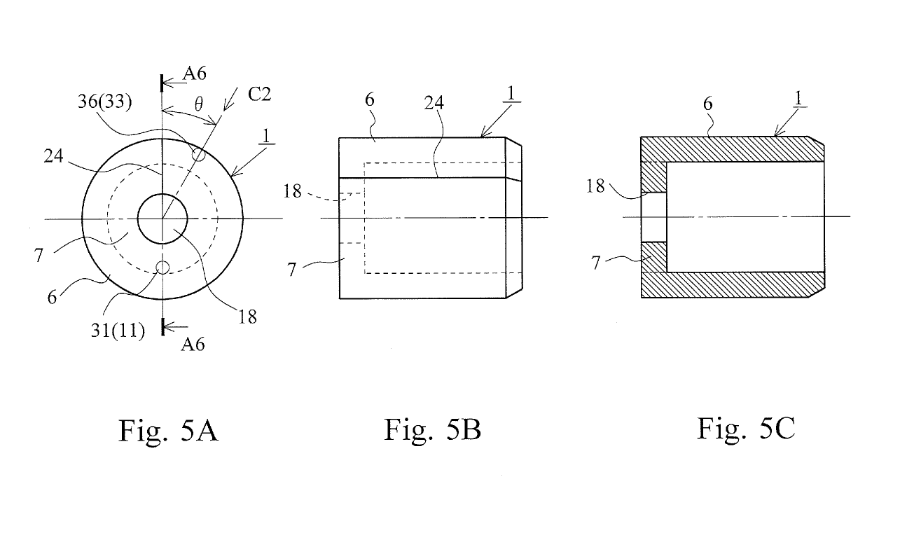

Next, the ejector sleeve 14 extrudes the cylindrical article 1 in the cavity 5 to the outside of the cavity 5. Thus, the cylindrical article 1 illustrated in FIG. 5 is formed.

With the injection molding mold 2 according to the above-described embodiment, the directions of the reinforcing fibers 25 at the weld portion 24 and near the weld portion 24 in the injection-molded cylindrical article 1 are disturbed. The reinforcing fibers 25 at the weld portion 24 and near the weld portion 24 in the cylindrical article 1 tangle (see FIG. 6). Accordingly, the weld portion 24 in the cylindrical article 1 is less likely to be noticeable, and the strength at the weld portion 24 in the cylindrical article 1 is improved.

With the injection molding method according to the embodiment, the directions of the reinforcing fibers 25 at the weld portion 24 and near the weld portion 24 in the injection-molded cylindrical article 1 are disturbed. The reinforcing fibers 25 at the weld portion 24 and near the weld portion 24 in the cylindrical article 1 tangle (see FIG. 6). Accordingly, the weld portion 24 in the cylindrical article 1 is less likely to be noticeable, and the strength at the weld portion 24 in the cylindrical article 1 is improved.

In the cylindrical article 1 according to the embodiment, the directions of the reinforcing fibers 25 at the weld portion 24 and near the weld portion 24 are disturbed, and the reinforcing fibers 25 at the weld portion 24 and near the weld portion 24 tangle (see FIG. 6). Therefore, the weld portion 24 is less likely to be noticeable, improving the strength at the weld portion 24.

With the injection molding mold 2 according to the embodiment, while the aspect where the opening area of the molten resin introduction path 33 to the first cavity 8 is formed smaller than the opening area of the gate 11 to the first cavity 8 is described as the example, the configuration is not limited to this. As long as the molten resins containing the reinforcing fibers 25 in the cavity 5 are partially extruded into the reinforcing fiber orientation change concave portion 20 after the molten resin containing the reinforcing fibers 25 fills the cavity 5 and the directions of the reinforcing fibers 25 at the weld portion 24 and near the weld portion 24 are configured to be disturbed, the opening area of the molten resin introduction path 33 to the first cavity 8 may be formed equal to or larger than the opening area of the gate 11 to the first cavity 8.

### Third Embodiment

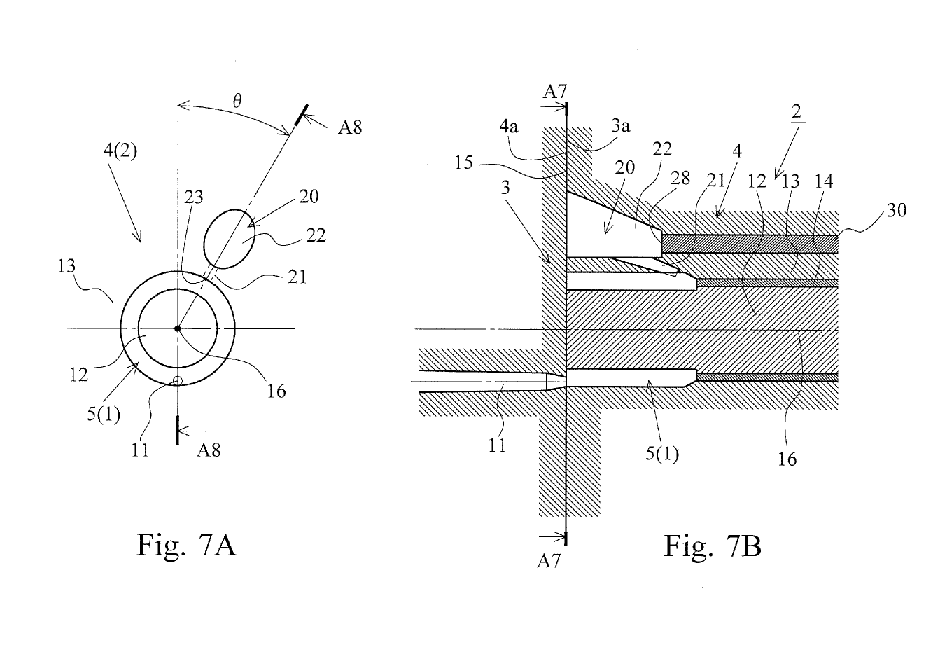

FIG. 7 are drawings illustrating the injection molding mold 2 for the cylindrical article 1 according to the third embodiment of the present invention. FIG. 7 are drawings illustrating a modification of the injection molding mold 2 according to the first embodiment. FIG. 7A is a drawing illustrating the injection molding mold illustrated in FIG. 7B taken along a line A7-A7 (a plan view of the second mold 4). FIG. 7B is a vertical cross-sectional view of the injection molding mold 2 (a cross-sectional view of the injection molding mold 2 illustrated taken along a line A8-A8 in FIG. 7A).

The injection molding mold 2 according to the embodiment differs from the injection molding mold 2 according to the first embodiment in the shape of the cavity 5 and the position of the gate 11. However, since the other basic configurations are similar to those of the injection molding mold 2 according to the first embodiment, reference numerals identical to the injection molding mold 2 according to the first embodiment are assigned to the corresponding components of the injection molding mold 2 according to the first embodiment, and therefore the following omits the explanation overlapping with the explanation of the first embodiment.

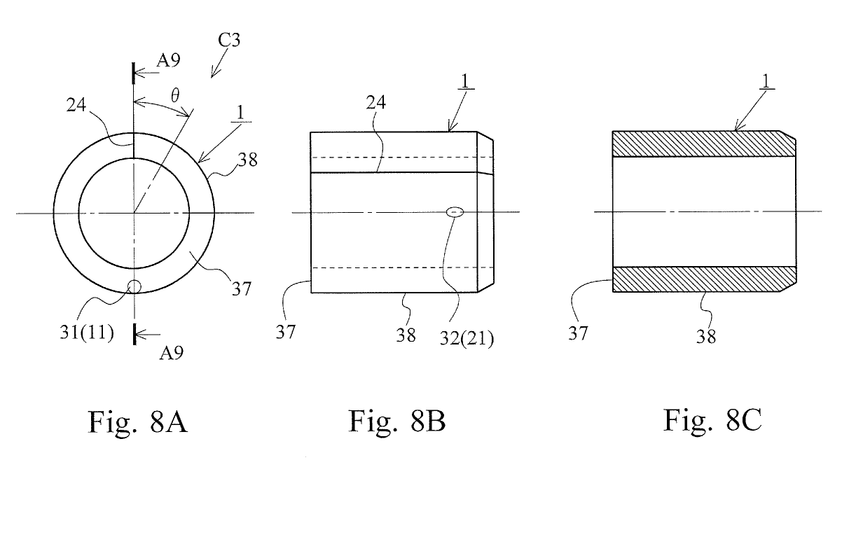

As illustrated in FIG. 7, with the injection molding mold 2, the cylindrical article 1 produced through the injection molding has the cylindrical shape and does not include a hollow circular plate (see FIG. 8). Therefore, the injection molding mold 2 does not include the second cavity 10 according to the first embodiment. The cavity 5 is constituted of only a part corresponding to the first cavity 8 of the injection molding mold 2 according to the first embodiment. The gate 11 is formed in the first mold 3 so as to open to the one end of the cavity 5.

The molten resin introduction path 21 of the reinforcing fiber orientation change concave portion 20, which is formed in the second mold 4, similar to the injection molding mold 2 according to the first embodiment, is disposed at the position additionally rotated by the angle θ clockwise from the position opposed to the gate 11 around the central axis 16 of the inner mold portion 12 (the position rotated clockwise by 180°+θ). Consequently, the opening 23 of the molten resin introduction path 21 on the cavity 5 side is displaced from the weld portion 24 where the molten resins containing the reinforcing fibers injected from the gate 11 into the cavity 5 join together. The molten resins containing the reinforcing fibers filled in the cavity 5 are partially flown from the molten resin introduction path 21 into the molten resin chamber 22, thus disturbing the directions of the reinforcing fibers 25 at the weld portion 24 and near the weld portion 24 (see FIG. 3). This complexly tangles the reinforcing fibers 25 at the weld portion 24 and near the weld portion 24 in the cavity 5, thus improving the strength at the weld portion 24 and the portion near the weld portion 24 in the cylindrical article 1. While the example of the molten resin introduction path 21 opening to the other end of the cavity 5 is described above, the configuration is not limited to this. The molten resin introduction path 21 may be disposed at the one end of the cavity 5 or may be disposed between the one end and the other end.

With the injection molding mold 2 according to the above-described embodiment, the directions of the reinforcing fibers 25 at the weld portion 24 and near the weld portion 24 in the injection-molded cylindrical article 1 are disturbed. The reinforcing fibers 25 at the weld portion 24 and near the weld portion 24 in the cylindrical article 1 tangle (see FIG. 3). Accordingly, the weld portion 24 in the cylindrical article 1 is less likely to be noticeable, and the strength at the weld portion 24 in the cylindrical article 1 is improved.

Although the injection molding mold 2 used for the injection molding method according to the embodiment slightly differs from the injection molding mold 2 according to the first embodiment, the injection molding method is similar to the method according to the first embodiment. Accordingly, the injection molding method according to the embodiment can obtain the effects similar to the injection molding method according to the first embodiment.

FIG. 8 are drawings illustrating the cylindrical article 1 produced through the injection molding with the injection molding mold 2 according to the embodiment. FIG. 8A is a front view of the cylindrical article 1. FIG. 8B is a side view of the cylindrical article 1 viewed from the arrow C3 direction in FIG. 8A. FIG. 8C is a cross-sectional view of the cylindrical article 1 illustrated taken along a line A9-A9 in FIG. 8A.

As illustrated in FIG. 8, the separation mark 31 of the gate 11 is formed on an end surface 37 at the one end of the cylindrical article 1. The separation mark 32 of the molten resin introduction path 21 is formed at a position displaced from the weld portion 24 on an outer peripheral surface 38 at the other end of the cylindrical article 1. The cylindrical article 1 changes the direction in which the reinforcing fibers 25 at the weld portion 24 and near the weld portion 24 head for the separation mark 32 of the molten resin introduction path 21. Thus, the reinforcing fibers 25 at the weld portion 24 and near the weld portion 24 complexly tangle.

In the cylindrical article 1 according to the embodiment, similar to the cylindrical article 1 according to the first embodiment, the directions of the reinforcing fibers 25 at the weld portion 24 and near the weld portion 24 are disturbed, and the reinforcing fibers 25 at the weld portion 24 and near the weld portion 24 tangle (see FIG. 3). Therefore, the weld portion 24 is less likely to be noticeable, improving the strength at the weld portion 24.

### Fourth Embodiment

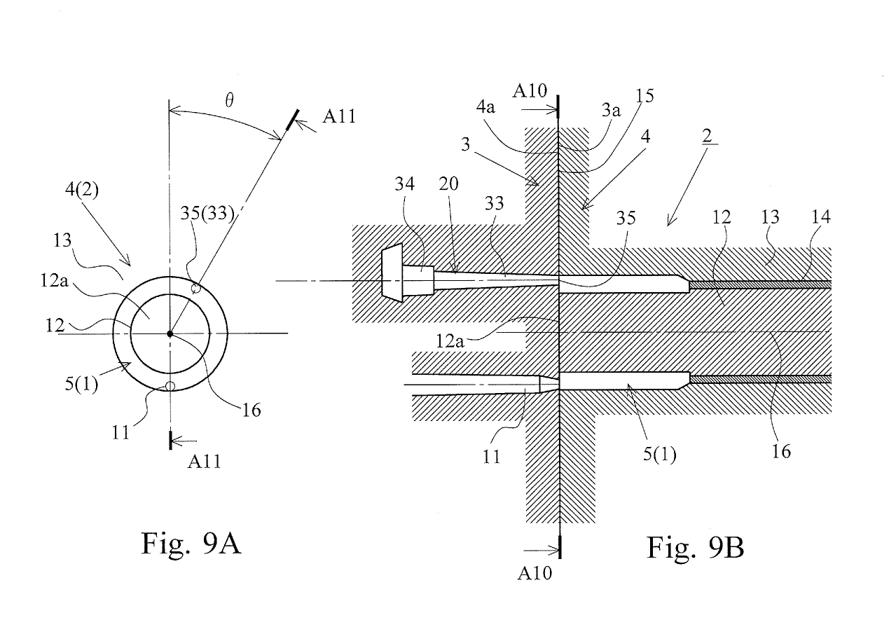

FIG. 9 are drawings illustrating the injection molding mold 2 for the cylindrical article 1 according to the fourth embodiment of the present invention. FIG. 9 are drawings illustrating a modification of the injection molding mold 2 according to the second embodiment. FIG. 9A is a drawing illustrating the injection molding mold 2 illustrated in FIG. 9B taken along a line A10-A10 (a plan view of the second mold 4). FIG. 9B is a vertical cross-sectional view of the injection molding mold 2 (a cross-sectional view of the injection molding mold 2 illustrated taken along a line A11-A11 in FIG. 9A).

The injection molding mold 2 according to the embodiment differs from the injection molding mold 2 according to the second embodiment in the shape of the cavity 5. However, since the other basic configurations are similar to those of the injection molding mold 2 according to the second embodiment, reference numerals identical to the injection molding mold 2 according to the second embodiment are assigned to the corresponding components of the injection molding mold 2 according to the second embodiment, and therefore the following omits the explanation overlapping with the explanation of the second embodiment.

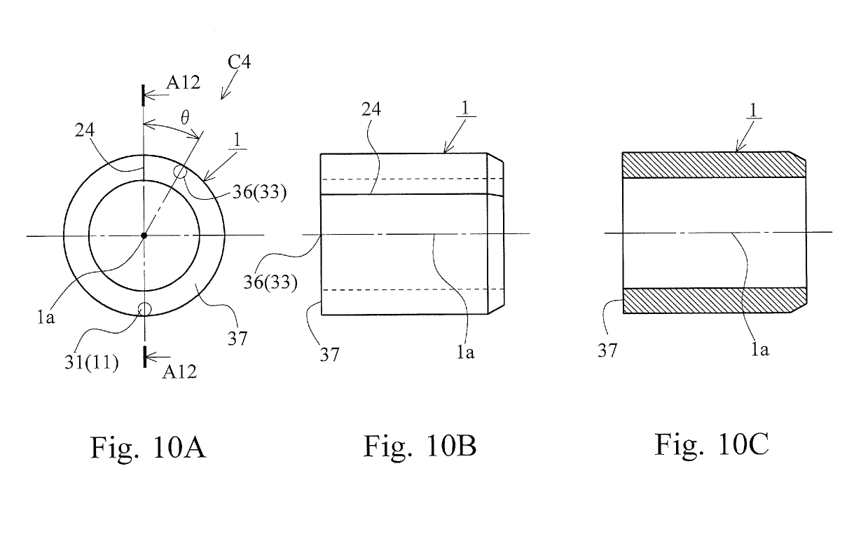

As illustrated in FIG. 9, with the injection molding mold 2, the cylindrical article 1 produced through the injection molding has the cylindrical shape and does not include the hollow circular plate (see FIG. 10). Therefore, the injection molding mold 2 does not include the second cavity 10 according to the second embodiment. The cavity 5 is constituted of only a part corresponding to the first cavity 8 of the injection molding mold 2 according to the second embodiment. The gate 11 is formed in the first mold 3 so as to open to the one end of the cavity 5.

The molten resin introduction path 33 of the reinforcing fiber orientation change concave portion 20 formed in the first mold 3 is, similar to the injection molding mold 2 according to the second embodiment, disposed at the position additionally rotated by the angle θ clockwise from the position opposed to the gate 11 around the central axis 16 of the inner mold portion 12 (the position rotated clockwise by 180°+θ). Consequently, the opening 35 of the molten resin introduction path 33 on the cavity 5 side is displaced from the weld portion 24 where the molten resins containing the reinforcing fibers injected from the gate 11 into the cavity 5 join together. The molten resins containing the reinforcing fibers filled in the cavity 5 are partially flown from the molten resin introduction path 33 into the molten resin chamber 34, thus disturbing the directions of the reinforcing fibers 25 at the weld portion 24 and near the weld portion 24 (see FIG. 6). This complexly tangles the reinforcing fibers 25 at the weld portion 24 and near the weld portion 24 in the cavity 5, thus improving the strength at the weld portion 24 and the portion near the weld portion 24 in the cylindrical article 1.

With the injection molding mold 2 according to the above-described embodiment, the directions of the reinforcing fibers 25 at the weld portion 24 and near the weld portion 24 in the injection-molded cylindrical article 1 are disturbed. The reinforcing fibers 25 at the weld portion 24 and near the weld portion 24 in the cylindrical article 1 tangle (see FIG. 6). Accordingly, the weld portion 24 in the cylindrical article 1 is less likely to be noticeable, and the strength at the weld portion 24 in the cylindrical article 1 is improved.

Although the injection molding mold 2 used for the injection molding method according to the embodiment slightly differs from the injection molding mold 2 according to the second embodiment, the injection molding method is similar to the method according to the second embodiment. Accordingly, the injection molding method according to the embodiment can obtain the effects similar to the injection molding method according to the second embodiment.

FIG. 10 are drawings illustrating the cylindrical article 1 produced through the injection molding with the injection molding mold 2 according to the embodiment. FIG. 10A is a front view of the cylindrical article 1. FIG. 10B is a side view of the cylindrical article 1 viewed from the arrow C4 direction in FIG. 10A. FIG. 10C is a cross-sectional view of the cylindrical article 1 illustrated taken along a line A12-A12 in FIG. 10A.

As illustrated in FIG. 10, the separation mark 31 of the gate 11 is formed on the end surface 37 at the one end of the cylindrical article 1. The separation mark 36 of the molten resin introduction path 33 is formed displaced from the weld portion 24 at a position rotated from the separation mark 31 of the gate 11 clockwise by 180°+θ around a central axis la on the end surface 37 at the one end of the cylindrical article 1. The cylindrical article 1 changes the direction in which the reinforcing fibers 25 at the weld portion 24 and near the weld portion 24 head for the separation mark 36 of the molten resin introduction path 33. Thus, the reinforcing fibers at the weld portion 24 and near the weld portion 24 tangle (see FIG. 6).

In the cylindrical article 1 according to the embodiment, similar to the cylindrical article 1 according to the second embodiment, the directions of the reinforcing fibers 25 at the weld portion 24 and near the weld portion 24 are disturbed, and the reinforcing fibers 25 at the weld portion 24 and near the weld portion 24 tangle (see FIG. 6). Therefore, the weld portion 24 is less likely to be noticeable, improving the strength at the weld portion 24.

### Other Embodiments

The reinforcing fiber orientation change concave portion 20 is not necessarily to be at the positions in the injection molding mold 2 according to the first to the fourth embodiments. As long as the directions of the reinforcing fibers at the weld portion 24 and near the weld portion 24 in the injection-molded cylindrical article 1 are disturbed and the strength at the weld portion 24 in the cylindrical article 1 can be improved, the reinforcing fiber orientation change concave portion 20 may be disposed at any position in the direction along the central axis 16.

While the first and the second embodiments describe the aspect of the uniform thicknesses of the cylinder portion 6 and the hollow circular plate 7 in the cylindrical article 1 as the example, the thickness of the cylinder portion 6 and the thickness of the hollow circular plate 7 in the cylindrical article 1 may be changed. While the third and the fourth embodiments describe the aspect of the uniform thickness of the cylindrical article 1 as the example, the thickness of the cylindrical article 1 may be changed.

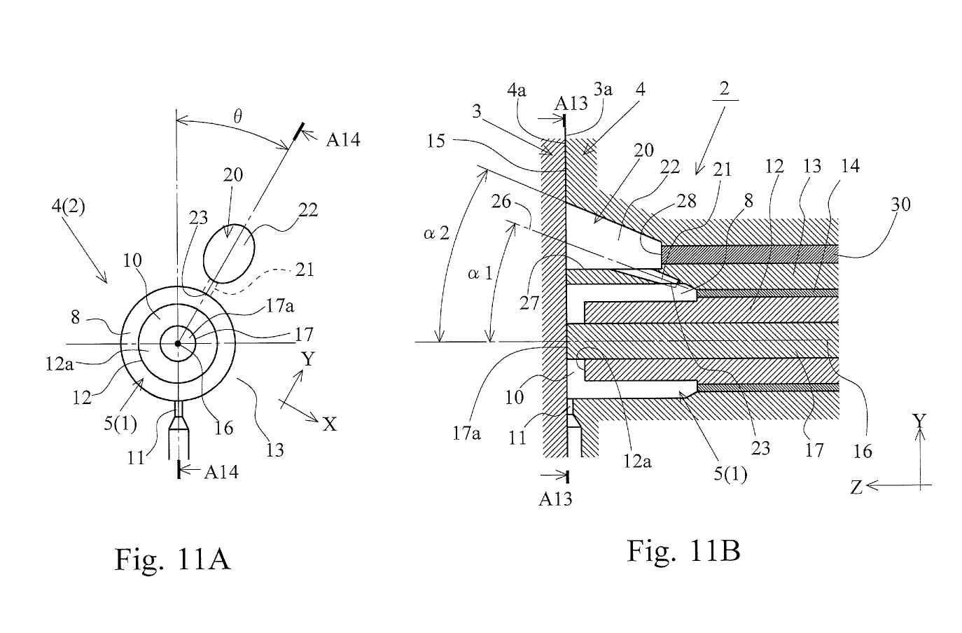

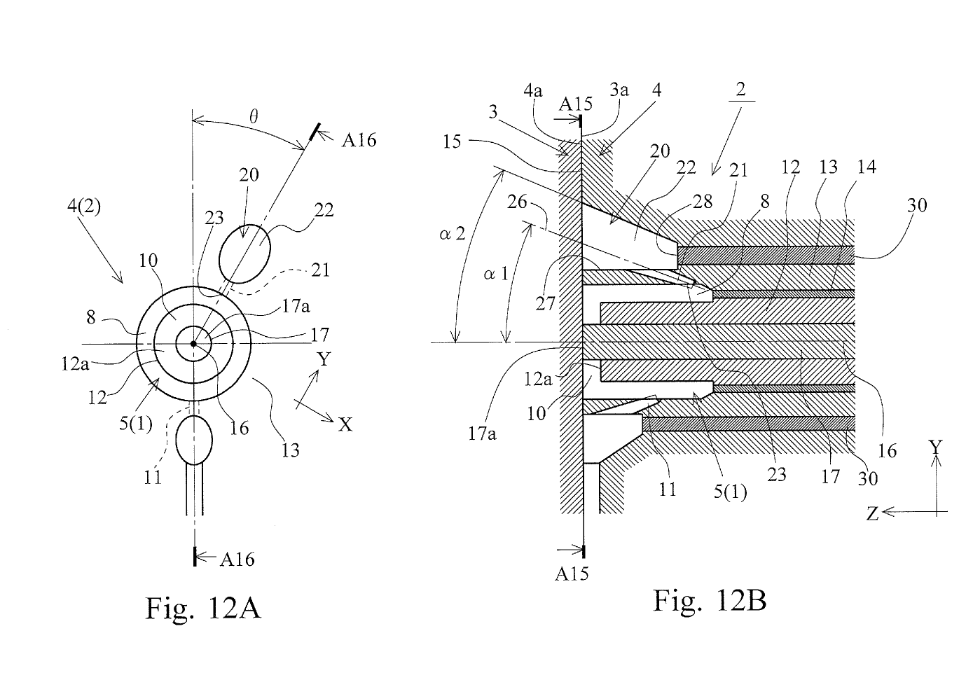

While the respective embodiments describe the pinpoint gate as the example of the gate 11, the configuration is not limited to this. A side gate (see FIG. 11), a tunnel gate (see FIG. 12), or a similar gate where the molten resins containing the reinforcing fibers are joined together in the cavity 5 to generate the weld portion is thought to be applied. The injection molding molds 2 illustrated in FIG. 11 and FIG. 12 are modifications of the injection molding mold 2 according to the first embodiment illustrated in FIG. 1. FIG. 11 and FIG. 12 assign the identical reference numerals to the components common to the injection molding mold 2 according to the first embodiment, and therefore the following omits the explanation overlapping with the explanation of the injection molding mold 2 according to the first embodiment.

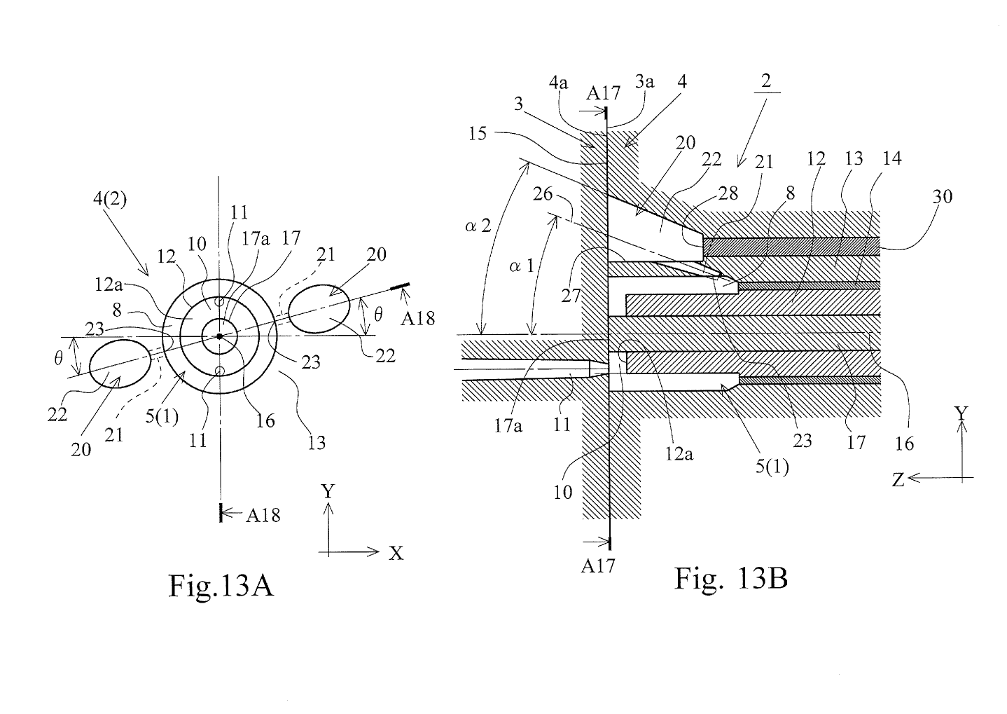

While the respective embodiments describe the aspect where the gate 11 is disposed only at one site for the one cavity 5 as the example, the configuration is not limited to this. The gates 11 may be disposed at a plurality of sites for the one cavity 5 (see FIG. 13). As illustrated in FIG. 13, the reinforcing fiber orientation change concave portions 20 are disposed by the identical number to the gates 11. That is, in the case where the pair of gates 11 are disposed on a straight line along the Y-axis and a straight line passing through the central axis 16, the pair of reinforcing fiber orientation change concave portions 20 are arranged displaced by a predetermined angle (θ) anticlockwise from the straight line along an X-axis and the straight line passing through the central axis 16. As illustrated in FIG. 13A, the pair of gates 11 and 11 are point-symmetric with respect to the central axis 16. As illustrated in FIG. 13A, the pair of reinforcing fiber orientation change concave portions 20 are point-symmetric with respect to the central axis 16. The pair of reinforcing fiber orientation change concave portions 20 may be arranged displaced by the predetermined angle (θ) clockwise from the straight line along the X-axis and the straight line passing through the central axis 16. In FIG. 13A, the weld portion is formed at a part where the molten resins containing the reinforcing fibers injected from the pair of gates 11 and 11 into the cavity 5 join together (the part on the straight line along the X-axis and the straight line passing through the central axis 16). While the injection molding mold 2 illustrated in FIG. 13 describes the two-point gates as the example, the configuration is not limited to this. Multipoint gates of three-point gates or more may be disposed.

### REFERENCE SINGS LIST

1 Cylindrical article
2 Injection molding mold
5 Cavity
11 Gate
20 Reinforcing fiber orientation change concave portion
24 Weld
25 Reinforcing fiber

The invention claimed is:

1. An injection molding mold for a cylindrical article where a molten resin containing reinforcing fibers is injected from a gate into a cavity to join the molten resins containing the reinforcing fibers together in the cavity to form a weld portion, the injection molding mold for the cylindrical article comprising
a reinforcing fiber orientation change concave portion formed at a position displaced from the weld portion, the reinforcing fiber orientation change concave portion opening to the cavity, wherein
the reinforcing fiber orientation change concave portion causes the molten resins containing the reinforcing fibers in the cavity to partially flow into the reinforcing fiber orientation change concave portion to disturb directions of the reinforcing fibers at the weld portion.

2. The injection molding mold for the cylindrical article according to claim 1, wherein:
the cylindrical article includes:
a cylinder portion; and
a hollow circular plate formed integrally with one end of the cylinder portion,
the cavity includes:
a first cavity that shapes the cylinder portion; and
a second cavity positioned at one end of the first cavity to shape the hollow circular plate,
the gate opens to the second cavity, and
the reinforcing fiber orientation change concave portion opens to the first cavity.

3. The injection molding mold for the cylindrical article according to claim 1, wherein:
the cylindrical article includes:
a cylinder portion; and
a hollow circular plate formed integrally with one end of the cylinder portion,
the cavity includes:
a first cavity that shapes the cylinder portion; and
a second cavity positioned at one end of the first cavity to shape the hollow circular plate,
the gate opens to the second cavity, and
the reinforcing fiber orientation change concave portion opens to an other end of the first cavity.

4. The injection molding mold for the cylindrical article according to claim 1, wherein:
the cylindrical article includes:
a cylinder portion; and
a hollow circular plate formed integrally with one end of the cylinder portion in a direction along a central axis of the cylinder portion,
the cavity includes:
a first cavity that shapes the cylinder portion; and
a second cavity positioned at one end of the first cavity to shape the hollow circular plate,
the gate opens to the second cavity, and
the reinforcing fiber orientation change concave portion opens to the one end of the first cavity.

5. The injection molding mold for the cylindrical article according to claim 1, wherein:
the cylindrical article has a cylindrical shape,
the gate opens to one end of the cavity, and
the reinforcing fiber orientation change concave portion opens to an other end of the cavity.

6. The injection molding mold for the cylindrical article according to claim 1, wherein:
the cylindrical article has a cylindrical shape, and
the gate and the reinforcing fiber orientation change concave portion open to one end of the cavity.

7. The injection molding mold for the cylindrical article according to claim 1, wherein:
the cylindrical article has a cylindrical shape,
the gate opens to one end of the cavity, and
the reinforcing fiber orientation change concave portion opens at a position between the one end and an other end of the cavity.

8. An injection molding method for a cylindrical article that injects a molten resin containing reinforcing fibers from a gate into a cavity to join the molten resins containing the reinforcing fibers together in the cavity to form a weld portion, the injection molding method for the cylindrical article comprising:
disposing a reinforcing fiber orientation change concave portion at a position displaced from the weld portion, the reinforcing fiber orientation change concave portion opening to the cavity; and
flowing the molten resins containing the reinforcing fibers filling the inside of the cavity partially into the reinforcing fiber orientation change concave portion to disturb directions of the reinforcing fibers at the weld portion.

9. A cylindrical article made of a fiber-reinforced resin material where a molten resin containing reinforcing fibers is injected from a gate into a cavity to join the molten resins containing the reinforcing fibers together in the cavity to form a weld portion, the cylindrical article made of the fiber-reinforced resin material, wherein
the molten resins containing the reinforcing fibers in the cavity are partially flown into a reinforcing fiber orientation change concave portion opening to the cavity to disturb directions of the reinforcing fibers at the weld portion.
